(19) United States
(12) Patent Application Publication
(10) Pub. No.: US 2019/0136981 A1
(43) Pub. Date: May 9, 2019

(54) DOUBLE ECCENTRIC VALVE

(71) Applicant: AISAN KOGYO KABUSHIKI KAISHA, Obu-shi, Aichi-ken (JP)

(72) Inventors: Takashige INAGAKI, Obu-shi (JP); Sunao KITAMURA, Nagoya-shi (JP); Shinji KAWAI, Gifu-shi (JP); Naruto ITO, Nissin-shi (JP); Mamoru YOSHIOKA, Nagoya-shi (JP)

(73) Assignee: AISAN KOGYO KABUSHIKI KAISHA, Obu-shi, Aichi-ken (JP)

(21) Appl. No.: 16/096,271

(22) PCT Filed: Mar. 30, 2017
(86) PCT No.: PCT/JP2017/013183

§ 371 Date: Oct. 24, 2018

(30) Foreign Application Priority Data
Jun. 1, 2016 (JP) 2016-109920
Sep. 13, 2016 (JP) 2016-178481

(51) Int. Cl. F16K 1/20; F16K 1/02; F16K 31/04

(52) U.S. Cl. CPC F16K 1/20; F16K 31/041; F16K 1/02

(57) ABSTRACT

In an EGR valve including a double eccentric valve, a passage is divided into upstream and downstream passages with the valve seat as the boundary and the valve element is disposed in the upstream passage. The valve element includes a first side part and a second side part that have as a boundary a virtual surface extending from the axis of the rotary shaft parallel to the direction in which the axis of the valve element extends. When the valve element rotates in the valve-opening direction from the fully closed state, the first side part rotates into the downstream passage and the second side part rotates into the upstream passage. A valve closing stopper is provided to be engageable with the first side part. A return spring for rotationally biasing the valve element in the fully closed state in the direction of valve-closing is also provided.

### TECHNICAL FIELD

The present invention relates to a double eccentric valve in which an axis of a rotary shaft as a rotation center of a valve element is placed away from a sealing surface of the valve element (primary eccentricity) and also placed away from an axis of the valve element (secondary eccentricity).

### BACKGROUND ART

For example, a double eccentric valve described in the Patent Document 1 mentioned below has been known as one example of this technique. The double eccentric valve is provided for the purposes of improving sealing performance in valve fully closing and preventing a valve element and a valve seat from abrasion due to rubbing against each other during rotation of the valve element. Namely, this double eccentric valve is specifically provided with a valve seat including a valve hole and a seat surface formed on an edge portion of the valve hole, a valve element formed on its outer periphery with a sealing surface in correspondence with the seat surface, a rotary shaft for rotating the valve element, a drive mechanism for drivingly rotate the rotary shaft, and a bearing supporting the rotary shaft. Therein, the rotary shaft is configured to receive an urging force on its drive-mechanism-side so that the valve element and a valve-element-side of the rotary shaft are pressed against the valve seat with respect to the bearing serving as a fulcrum. The rotary shaft is supported by a housing in cantilever configuration to prevent locking of the rotary shaft due to foreign substances stuck between the valve element and the valve seat at the time of valve fully closing. This configuration allows creation of some bearing backlash between the valve element and the valve seat. The bearing backlash is utilized to bring the valve element into contact and sealing with the valve seat by the drive mechanism so that gas leakage between the valve element and the valve seat during valve fully closing is prevented.

The above-configured double eccentric valve is, for example, adopted for an EGR valve configured to regulate a flow rate of EGR gas flowing through an exhaust gas recirculation (EGR) passage in an engine system which is provided with a supercharger.

### RELATED ART DOCUMENTS

### Patent Documents

Patent Document 1: International Application Publication No. WO2016/002599A1

### SUMMARY OF INVENTION

### Problems to be Solved by the Invention

However, application of the above-mentioned double eccentric valve to an EGR valve has the following problem. When supercharging pressure acts on the valve element from an intake-passage side through the EGR passage to open the valve element, the valve element could rise from the valve seat and fresh air could flow into the exhaust passage. As a result, the fresh air flows into a catalyst provided in the exhaust passage, which may cause degradation in exhaust gas purification performance of the catalyst.

The present invention has been made in view of the above circumstances and has a purpose of providing a double eccentric valve achieving prevention of fluid leakage between the valve element and the valve seat by sealing the valve element with the valve seat even when the valve element is subjected to a force to lift or raise the valve element from the valve seat during valve fully closing.

### Means of Solving the Problems

To achieve the above purpose, one aspect of the invention provides a double eccentric valve comprising: a valve seat of an annular shape including a valve hole and an annular seat surface formed in the valve hole; a valve element of a disc like shape including an annular sealing surface formed on an outer periphery in correspondence with the seat surface; a housing including a passage in which fluid flows; the valve seat and the valve element being placed in the passage, the passage being partitioned into an upstream passage and a downstream passage with respect to the valve seat as a boundary and the valve element being placed in the upstream passage, a rotary shaft configured to rotate the valve element; and a bearing rotatably supporting the rotary shaft in the housing, an axis of the rotary shaft being placed away from the sealing surface of the valve element and placed away from an axis of the valve element, the valve element including a first side part and a second side part partitioned with respect to a boundary defined by a virtual surface extending in parallel with a direction extending from the axis of the rotary shaft to the axis of the valve element, and the first side part configured to rotate toward the downstream passage and the second side part configured to rotate toward the upstream passage when the valve element rotates in a valve open direction from a fully-closed state in which the valve element is seated in the valve seat, wherein the double eccentric valve comprises: a valve closing stopper engageably provided in the first side part to restrict rotation of the valve element in the fully-closed state toward a valve closing direction which is opposite to the valve open direction; and a first rotation urging member to urge and rotate the valve element in the fully-closed state toward the valve closing direction.

According to the above configuration (1), the valve closing stopper is provided to be engageable with the first side part of the valve element in order to restrain rotation of the valve element in the fully closed state in the valve closing direction opposite to the valve opening direction. Accordingly, even if the fully-closed valve element is about to rise from the valve seat, the first side part of the valve element contacts the valve closing stopper, and thus the valve element is prevented from rising from the valve seat. Further, the fully-closed valve element is urged to rotate in the valve closing direction by the first rotation urging member. The valve element is thus urged to rotate in the valve closing direction about a contact portion with the valve closing stopper of the first side part as a fulcrum, causing tremor in the valve element and this tremor brings the sealing surface into contact with the seat surface of the valve seat.

(2) To achieve the above purpose, in the above configuration (1), preferably, the double eccentric valve comprises a second rotation urging member to urge and further rotate the valve element in the valve closing direction when the valve element is in the fully-closed state and high-pressure fluid acts on the downstream passage.

According to the above configuration (2), in addition to an operation of the above configuration (1), the valve element is further urged in the valve closing direction by the second rotation urging member when the valve element is in the fully closed state and the high-pressure fluid acts on the downstream passage. Accordingly, when the valve closing stopper restricts rise of the valve element from the valve seat caused by operation of the high-pressure fluid, the valve element tremors to bring the sealing surface into contact with the seat surface of the valve seat.

(3) To achieve the above purpose, in the above configuration (1) or (2), the valve closing stopper is placed adjacent to an outer periphery of the first side part of the valve element within an angular range defined by a first virtual line extending orthogonal to the axis of the rotary shaft centering about the axis of the valve element, extending from the axis of the valve element to the first side part, and a second virtual line extending in parallel with the axis of the rotary shaft from the axis of the valve element to a leading end portion of the rotary shaft in planar view of the valve element.

According to the above configuration (3), in addition to the operation of the above configuration (1) or (2), the valve closing stopper is placed adjacent to the outer periphery of the first side part of the valve element within the angular range defined by the first virtual line and the second virtual line. Accordingly, the valve element contacts with the valve closing stopper, and thus at least any one of the tremor of the valve element in the rotation direction about the rotary shaft and the tremor of the valve element in the axial direction of the valve element is restrained.

(4) To achieve the above purpose, in the above configuration (3), the valve closing stopper is placed in a middle point of the angular range.

According to the above configuration (4), in addition to the operation of the above configuration (3), the valve closing stopper is placed in the middle of the angular range, and thus the valve element contacts the valve closing stopper, restricting both the tremor of the valve element in the rotation direction about the rotary shaft and the tremor of the valve element in the axial direction of the valve element to the maximum.

(5) To achieve the above purpose, in the above configuration (3), the valve closing stopper is placed on a side closer to the first virtual line than the middle point of the angular range.

According to the above configuration (5), in addition to the operation of the above configuration (3), the valve element contacts the valve closing stopper, thus mainly restricting the tremor of the valve element in the rotation direction about the rotary shaft.

(6) To achieve the above purpose, in the above configuration (3), the valve closing stopper is placed on a side closer to the second virtual line than the middle point of the angular range.

According to the above configuration (6), in addition to the operation of the above configuration (3), the valve element contacts the valve closing stopper, thus mainly restricting the tremor of the valve element in the axial direction of the valve element.

(7) To achieve the above purpose, another aspect of the invention provides a poppet valve comprising: a valve seat of an annular shape including a valve hole and an annular seat surface formed in the valve hole; a valve element of an almost conical shape including an annular sealing surface formed on an outer periphery in correspondence with the seat surface; a housing including a passage in which fluid flows; the valve seat and the valve element being placed in the passage, the passage being partitioned into an upstream passage and a downstream passage with respect to the valve seat as a boundary and the valve seat being placed in the upstream passage, a valve shaft configured to move the valve element reciprocally and straightforward; and a bearing for movably supporting the valve shaft in an axial direction, the valve element being configured to move toward the upstream passage when the valve element moves in a valve open direction from a fully-closed state in which the valve element is seated in the valve seat, wherein the valve seat is provided to be engageable with the valve element to restrict movement of the valve element in the fully-closed state toward a valve closing direction, and the poppet valve includes: a first valve-closing urging member to urge the valve element in the fully-closed state in the valve closing direction; and a second valve-closing urging member to further urge the valve element in the valve closing direction when the valve element is in the fully-closed state and high-pressure fluid acts on the downstream passage.

According to the above configuration (7), when the first valve-closing urging member places the valve element in the fully closed state and the high-pressure fluid acts on the downstream passage, the second valve-closing urging member further urges the valve element in the valve closing direction in which the valve element is engaged with the valve seat. Accordingly, the valve element is prevented from rising from the valve seat caused by the action of the high-pressure fluid.

### Effects of the Invention

According to the above configuration (1), the valve element and the valve seat can be sealed even if the valve element is subjected to the force to lift the valve element from the valve seat during the valve fully closing, so that the fluid leakage between the valve element and the valve seat can be prevented.

According to the above configuration (2), the valve element and the valve seat can be sealed even if the valve element is subjected to the pressure of the high-pressure fluid to lift the valve element from the valve seat during the valve fully closing, so that the leakage of the high-pressure fluid between the valve element and the valve seat can be prevented.

According to the above configuration (3), in addition to the effect of the above configuration (1) or (2), rise of the valve element from the valve seat during the valve fully closing can be effectively restrained.

According to the above configuration (4), in addition to the effect of the above configuration (3), rise of the valve element from the valve seat during the valve fully closing can be restrained most effectively.

According to the above configuration (5), in addition to the effect of the above configuration (3), rise of the valve element from the valve seat in the rotation direction about the rotary shaft can be restrained.

According to the above configuration (6), in addition to the effect of the above configuration (3), rise of the valve element from the valve seat in the axial direction of the valve element can be restrained. Especially, the flow rate characteristics (the flow rate resolution) of the fluid in a small open range can be improved.

According to the above configuration (7), the valve element and the valve seat can be sealed even if the valve element is subjected to the pressure of the high-pressure fluid during the valve fully closing, thus effectively preventing the fluid leakage between the valve element and the valve seat. Further, since the valve element is prevented from rising caused by the supercharging pressure, the first valve-closing urging member and the second valve-closing urging member have no need to increase their size and have no need to improve their performance by the cooperative operation of the first valve-closing urging member and the second valve-closing urging member. As a result of this, size reduction and cost reduction can be achieved.

### BRIEF DESCRIPTION OF THE DRAWINGS

FIG. 1 is a schematic configurational view of a gasoline engine system in a first embodiment;

FIG. 2 is a perspective view of an EGR valve in the first embodiment;

FIG. 3 is a partially-cutaway perspective view of a valve section in a fully-closed state in the first embodiment;

FIG. 4 is a partially-cutaway perspective view of the valve section in a fully-open state in the first embodiment;

FIG. 5 is a plane sectional view of an EGR valve in the fully-closed state in the first embodiment;

FIG. 6 is a sectional view illustrating a relation of a valve seat, a valve element, a rotary shaft, and a main gear in the fully-closed state in the first embodiment;

FIG. 7 is a block diagram illustrating an electrical configuration of a second rotation urging member in the first embodiment;

FIG. 8 is a flow chart of rotation urging control in the first embodiment;

FIG. 9 is a sectional view of the valve seat, the valve element, and others in the first embodiment;

FIG. 10 is a sectional view of the valve seat, the valve element, and others in the first embodiment;

FIG. 11 is an enlarged sectional view of the valve seat and a part of a second side part in the first embodiment;

FIG. 12 is an enlarged sectional view of the valve seat and a part of a first side part in the first embodiment;

FIG. 13 is a plane sectional view of a part of the EGR valve in the fully-closed state in a second embodiment;

FIG. 14 is a sectional side view of a part of the EGR valve in the fully-closed state in the second embodiment;

FIG. 15 is a graph showing a relationship of pressure acting on the valve element and a leakage flow rate of the EGR valve when the valve closing stopper is in a position of “−45°” in the second embodiment;

FIG. 16 is a graph showing a relationship of the pressure acting on the valve element and the leakage flow rate of the EGR valve when the valve closing stopper is in a position of “90°” in the second embodiment;

FIG. 17 is a graph showing a relation of the pressure acting on the valve element and the leakage flow rate of the EGR valve when the valve closing stopper is in a position of “130°” in the second embodiment;

FIG. 18 is a plane sectional view of a part of the EGR valve in the fully-closed state in a third embodiment;

FIG. 19 is a graph showing EGR gas flow rate characteristics with respect to an open degree of the EGR valve in the third embodiment; and

FIG. 20 is a sectional view of an EGR valve including a DC-motor-operated poppet valve in a fourth embodiment.

### MODE FOR CARRYING OUT THE INVENTION

### First Embodiment

A first embodiment embodying an exhaust gas recirculation valve (an EGR valve) including a double eccentric valve of the present invention is explained in detail with reference to the accompanying drawings.

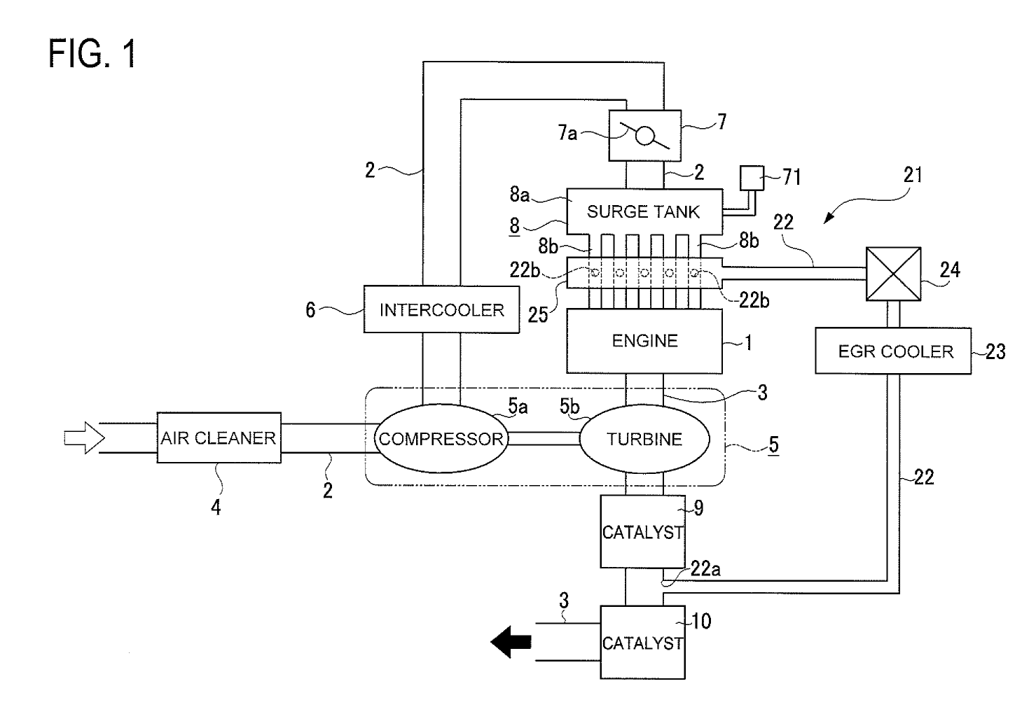

FIG. 1 is a schematic configurational view of a gasoline engine system of the present embodiment. The gasoline engine system mounted in an automobile is provided with a reciprocating engine 1. The engine 1 is formed with an intake passage 2 for introducing intake air into each cylinder and an exhaust passage 3 for discharging exhaust gas out of each cylinder. A supercharger 5 is provided in the intake passage 2 and the exhaust passage 3. In the intake passage 2, there are provided an air cleaner 4, a compressor 5a of the supercharger 5, an intercooler 6, a throttle device 7, and an intake manifold 8. The throttle device 7 is made to open and close a butterfly throttle valve 7a to regulate an intake amount in the intake passage 2. The intake manifold 8 includes a surge tank 8a and a plurality of branch pipes 8b branching off from the surge tank 8a and extending to each cylinder of the engine 1. In the exhaust passage 3, there are provided a turbine 5b of the supercharger 5, a first catalyst 9, and a second catalyst 10, both the 2 5 catalysts being placed in series to purify exhaust air. The engine 1 including known configuration is made to burn mixed air of fuel and the intake air and to discharge the exhaust air having been burned to the exhaust passage 3. The supercharger 5 is configured such that the turbine 5b is rotated by exhaust air flow and the compressor 5a is rotated in association with the rotation of the turbine 5b so that pressure of the intake air in the intake passage 2 increases.

This engine system is formed with an exhaust gas recirculation device (an EGR device) 21. The EGR device 21 is provided with an exhaust gas recirculation passage (an EGR passage) 22 to flow a part of the exhaust air discharged to the exhaust passage 3 from the engine 1 into the intake passage 2 as exhaust gas recirculation gas (EGR gas) and recirculate the EGR gas to each cylinder, an exhaust gas recirculation cooler (an EGR cooler) 23 provided in the EGR passage 22 to cool the EGR gas, and an exhaust gas recirculation valve (an EGR valve) 24 provided in the EGR passage 22 downstream of the EGR cooler 23 to regulate a flow rate of the EGR gas. The EGR passage 22 includes an inlet 22a and a plurality of outlets 22b. An EGR distribution pipe 25 including the plurality of outlets 22b is provided on a downstream side of the EGR passage 22. The EGR distribution pipe 25 is provided on or above branch passages 8b of the intake manifold 8. In the present embodiment, the inlet 22a of the EGR passage 22 is connected to the exhaust passage 3 between the catalyst 9 and the catalyst 10 which are placed in series in the exhaust passage 3. The plurality of outlets 22b of the EGR distribution pipe 25 are each communicated with each of the branch passages 8b. Each of the outlets 22b is thus communicated with each of the branch passages 8b so that EGR gas is evenly introduced into each cylinder through the branch passages 8b.

In the present embodiment, the EGR valve 24 is constituted by a motor-operated valve which is variable in its open degree. The EGR valve 24 preferably has characteristics of a large flow rate, high responsiveness, and high resolution. In the present embodiment, the EGR valve 24 adopts a configuration of “a double eccentric valve” described in JP Patent No. 5759646 as a basic structure, for example. This double eccentric valve is configured to meet the requirement of large flow rate control.

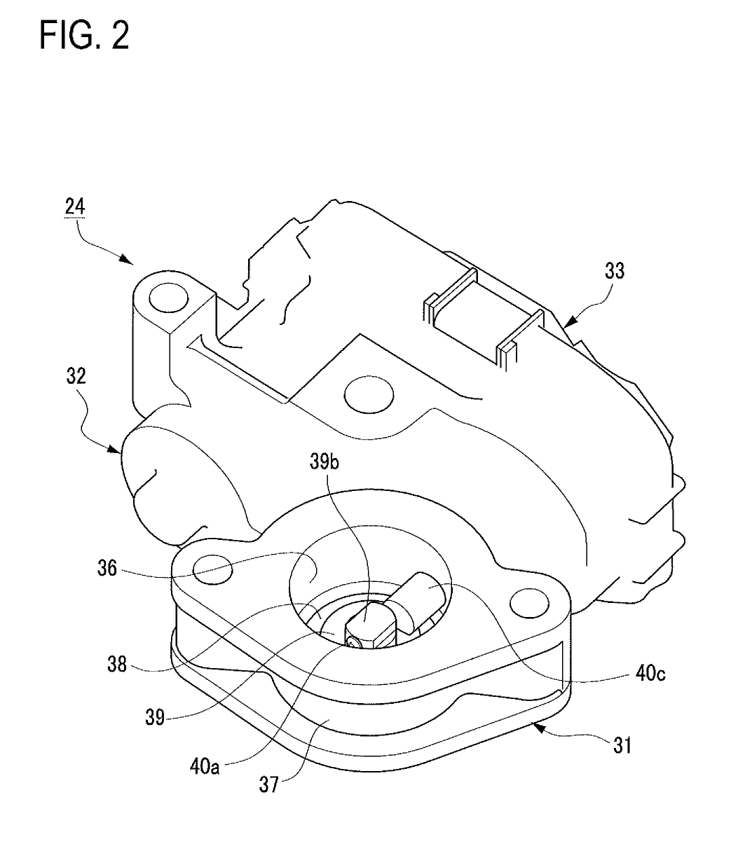

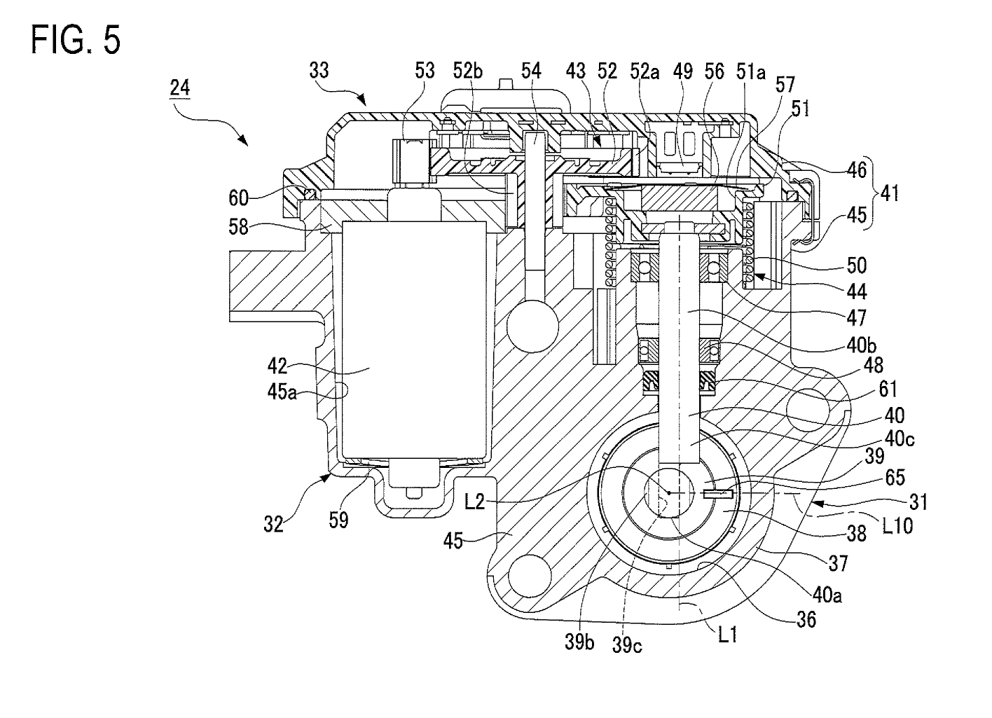

A basic configuration of the motor-operated EGR valve 24 including the double eccentric valve is explained below. FIG. 2 is a perspective view of the EGR valve 24. The EGR valve 24 includes a valve section 31 consisting of a double eccentric valve, a motor section 32 mounted with a motor 42 (see FIG. 5), and a speed reducing mechanism section 33 mounted with a speed reducing mechanism 43 (see FIG. 5). The valve section 31 includes a pipe 37 provided with a passage 36 in which the EGR gas flows. In the passage 36, a valve seat 38, a valve element 39, and a leading end portion 40c of a rotary shaft 40 are placed. To the rotary shaft 40, a rotational force of the motor 42 (see FIG. 5) is made to be transmitted via the speed reducing mechanism 43 (see FIG. 5).

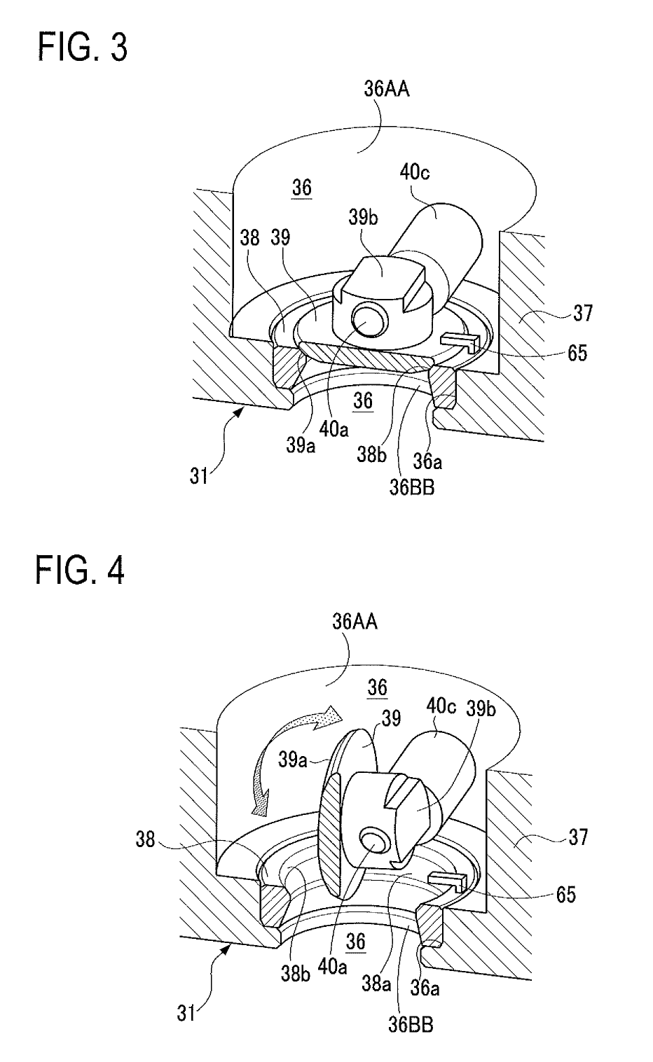

FIG. 3 is a partially-cutaway view of the valve section 31 in a valve fully-closed state where the valve element 39 is seated in the valve seat 38. FIG. 4 is a partially-cutaway view of the valve section 31 in a valve fully-open state where the valve element 39 is furthest away from the valve seat 38. As shown in FIGS. 3 and 4, the passage 36 is formed with a step portion 36a in which the valve seat 38 is press-fitted and fixed. The valve seat 38 of an annular shape has a valve hole 38a in its center. The valve hole 38a has an annular seat surface 38b on its periphery. The valve element 39 of a circular disc shape is formed on its outer periphery with an annular sealing surface 39a in correspondence with the seat surface 38b. The valve element 39 is fixed to the leading end portion 40c of the rotary shaft 40 to be integrally rotated with the rotary shaft 40. In FIGS. 3 and 4, the passage 36 is partitioned into an upstream passage 36AA and a downstream passage 36BB with respect to the valve seat 38 serving as a boundary. In FIGS. 3 and 4, the passage 36 on an upper side of the valve seat 38 indicates the upstream passage 36AA of EGR gas flow, and the passage 36 on a lower side of the valve seat 38 indicates the downstream passage 36BB of the EGR gas flow. The valve element 39 is placed in the upstream passage 36AA. In the present embodiment, the upstream passage 36AA represents “an exhaust-air side” which communicates with the exhaust passage 3 via the EGR passage 22, and the downstream passage 36BB represents “an intake-air side” which communicates with the intake passage 2 (the intake manifold 8) via the EGR passage 22.

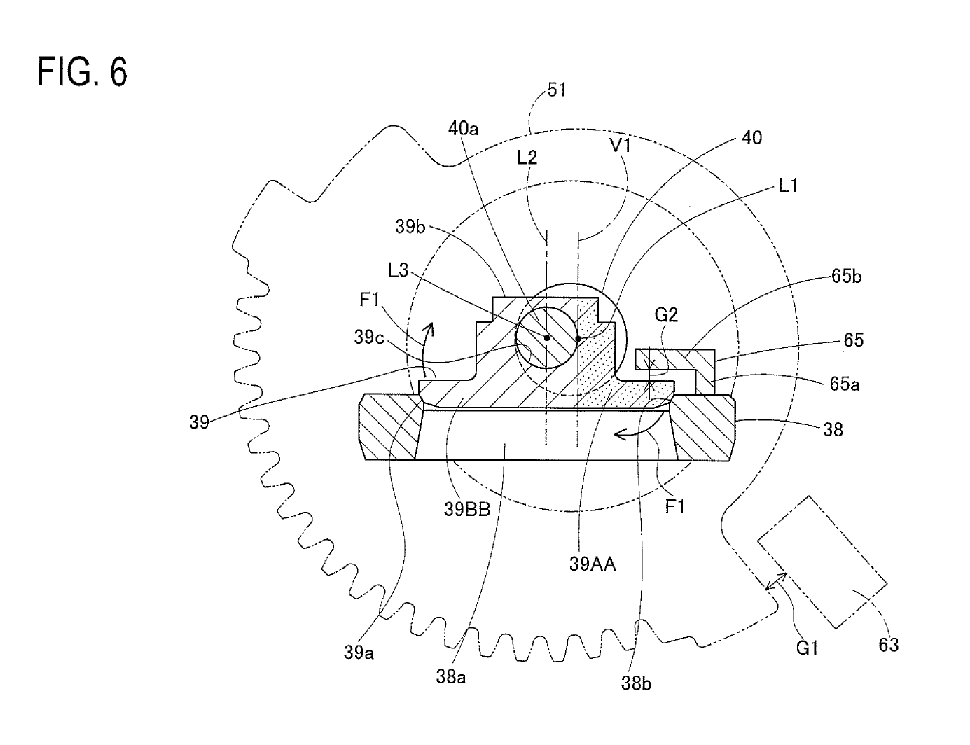

FIG. 5 is a plane sectional view of the EGR valve 24 in the fully-closed state. As shown in FIG. 5, the EGR valve 24 is provided with a body 41, the motor 42, the speed reducing mechanism 43, and a return mechanism 44 as main components other than the valve seat 38, the valve element 39, and the rotary shaft 40. The body 41 is provided with an aluminum valve housing 45, which includes the passage 36 and the pipe 37, and a synthetic-resin made end frame 46 enclosing an open end of the valve housing 45. The rotary shaft 40 and the valve element 39 are provided in the valve housing 45. Namely, the rotary shaft 40 includes the pin 40a on the leading end portion 40c to be attached with the valve element 39. The rotary shaft 40 has a free end on its leading end portion 40c provided with the pin 40a, and this leading end portion 40c is placed in the upstream passage 36AA with the valve element 39. In the present embodiment, the valve element 39 and the leading end portion 40c of the rotary shaft 40 are placed in the upstream passage 36AA, and the valve element 39 is allowed to seat in the valve seat 38 in this passage 36AA. The rotary shaft 40 further includes a proximal end portion 40b on an opposite side from the pin 40a and the shaft 40 is supported in cantilever configuration by the valve housing 45 at this proximal end portion 40b. The proximal end portion 40b of the rotary shaft 40 is further supported in a rotatable manner by the valve housing 45 via two bearings of a first bearing 47 and a second bearing 48 which are placed separately from each other. A rubber seal 61 is provided adjacent to the second bearing 48 between the rotary shaft 40 and the valve housing 45. The first bearing 47 and the second bearing 48 are each constituted by a ball bearing. The valve element 39 includes a protrusion 39b protruding upward (toward the upstream passage 36AA) on an axis L2 (see FIG. 6), and a pin hole 39c is formed in this protrusion 39b. The valve element 39 is fixed to the rotary shaft 40 by press-fitting and welding the pin 40a into the pin hole 39c.

In FIG. 5, the end frame 46 is fixed to the valve housing 45 by a plurality of clips (not shown). Inside the end frame 46 is provided with an open degree sensor 49 placed in correspondence with a proximal end of the rotary shaft 40 to detect an open degree (a valve open degree) of the valve element 39. To the proximal end portion 40b of the rotary shaft 40, a main gear 51 is fixed. Between the main gear 51 and the valve housing 45, a return spring 50 to urge and rotate the valve element 39 in a valve closing direction is provided. In the present embodiment, the return spring 50 corresponds to one example of a first rotation urging member of the present invention. A recessed portion 51a is formed on a rear side of the main gear 51 and a magnet 56 is accommodated in the recessed portion 51a. The magnet 56 is pressed from its upper side by a retainer plate 57 and fixed. Accordingly, integral rotation of the main gear 51 rotating with the valve element 39 and the rotary shaft 40 leads to changes in a magnetic field of the magnet 56, and the open degree sensor 49 is configured to detect the changes in the magnetic field as the valve open degree.

As shown in FIG. 5, the motor 42 is accommodated in an accommodation recess 45a formed in the valve housing 45. The motor 42 is fixed to the valve housing 45 in the accommodation recess 45a via a stopper plate 58 and a leaf spring 59. The motor 42 is drivingly connected to the rotary shaft 40 through the speed reducing mechanism 43 to open and close the valve element 39. Namely, a motor gear 53 fixed on an output shaft (not shown) of the motor 42 is drivingly connected to the main gear 51 via an intermediate gear 52. The intermediate gear 52 is configured as a two-stage gear including a large-diameter gear 52a and a small-diameter gear 52b. The intermediate gear 52 is rotatably supported by the valve housing 45 via a pin shaft 54. The large-diameter gear 52a is coupled with the motor gear 53 and the small-diameter gear 52b is coupled with the main gear 51. In the present embodiment, the speed reducing mechanism 43 is constituted by the gears 51 to 53. The main gear 51 and the intermediate gear 52 are made of resin material for weight reduction. A rubber gasket 60 is provided in an engagement portion of the valve housing 45 and the end frame 46. The gasket 60 hermetically seals inside the motor section 32 and the speed reducing mechanism section 33 against atmosphere.

Accordingly, as shown in FIG. 3, when the motor 42 is operated to rotate the motor gear 53 from the fully-closed state, rotation of the motor gear 53 is reduced its speed by the intermediate gear 52 and transmitted to the main gear 51. Thus, the rotary shaft 40 and the valve element 39 are rotated against an urging force of the return spring 50, thereby opening the passage 36. Namely, the valve element 39 is opened. For closing the valve element 39, the motor 42 rotates the motor gear 53 reversely. For keeping the valve element 39 open by a certain open degree, the motor 42 is made to generate a rotational force, and the generated rotational force is transmitted as a retaining force to the rotary shaft 40 through the intermediate gear 52 and the main gear 51. This retaining force makes balance with the urging force of the return spring 50, thus keeping the certain open degree of the valve element 39.

In the fully-closed state shown in FIG. 3, an excessive supercharging pressure may act on the downstream passage 36BB from the intake passage 2. In this case, the valve element 39 could rise from the valve seat 38 and the intake air could leak out to the upstream passage 36AA and flow into the exhaust passage 3. This could cause degradation in the catalysts 9 and 10, occurrence of backfire, and others in the exhaust passage 3. This rise of the valve element 39 in the present embodiment may occur due to the configuration that the rotary shaft 40 is supported in the valve housing 45 via the two bearings 47 and 48 and that the structure of the bearings 47 and 48 creates a micronic backlash. To address this problem, the EGR valve 24 is configured with a structure of preventing rise of the valve element 39 due to the excessive supercharging pressure during valve closing.

FIG. 6 is a sectional view showing a relation of the valve seat 38, the valve element 39, the rotary shaft 40, and the main gear 51 in the fully-closed state. In FIG. 6, an axis (a main axis) L1 of the rotary shaft 40 is located separately from the sealing surface 39a of the valve element 39 and separated from the axis L2 of the valve element 39. An axis (a sub-axis L3) of the pin 40a of the rotary shaft 40 extends in parallel with the main axis L1 and is positioned eccentrically in a radial direction of the rotary shaft 40 from the main axis L1. The valve element 39 includes a first side part 39AA (a shaded portion (indicated with dots) in FIG. 6) and a second side part 39BB (a non-shaded portion (indicated without dots) in FIG. 6) with respect to a boundary defined by a virtual surface V1 extending in parallel with the axis L2 of the valve element 39 from the main axis L1. When the valve element 39 rotates in the valve open direction (in a clockwise direction in FIG. 6) F1 about the main axis L1 of the rotary shaft 40 from the fully-closed state, the first side part 39AA rotates toward the downstream passage 36BB and the second side part 39BB rotates toward the upstream passage 36AA. When the valve element 39 is closed from the valve open state to the fully-closed state, the valve element 39 is made to rotate in the valve closing direction (in a counter-clockwise direction in FIG. 6) opposite to the valve open direction F1.

As shown in FIG. 6, a gear stopper 63 is provided on a rotation track of the main gear 51 to restrict rotation of the main gear 51. The gear stopper 63 is provided in the valve housing 45. In the fully-closed state of the valve element 39, a predetermined clearance G1 is formed between the main gear 51 and the gear stopper 63. The main gear 51 is thus allowed to rotate further from the fully-closed state until the gear 51 contacts the gear stopper 63. This configuration allows further rotation of the valve element 39 in the valve closing direction from the fully-closed state.

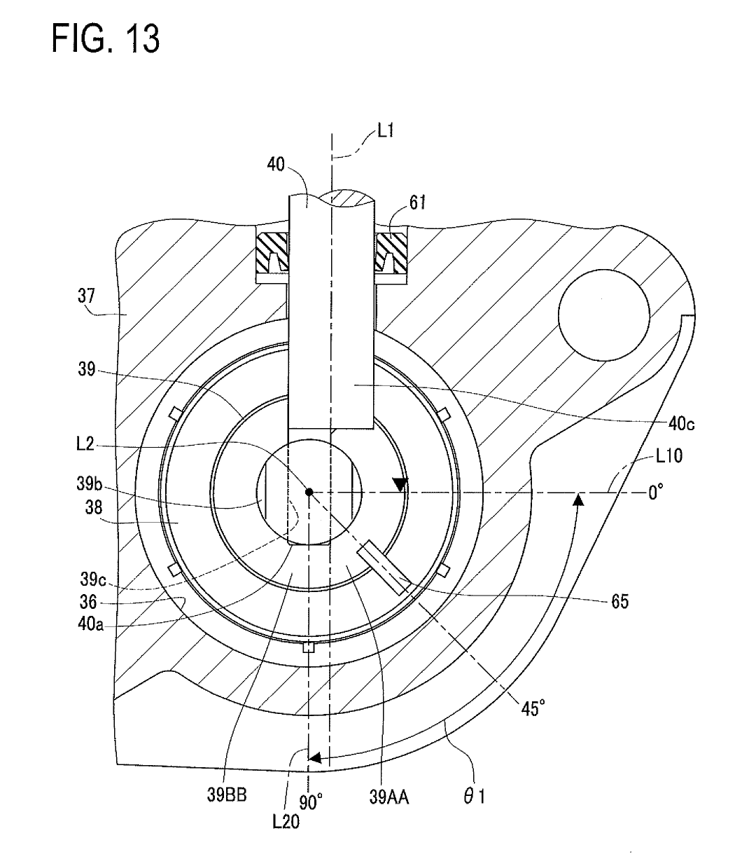

On the premise that the valve seat 38, the valve element 39, the rotary shaft 40, and the main gear 51 are arranged as mentioned above, the valve seat 38 is provided with a valve closing stopper 65 to restrict rotation of the fully-closed valve element 39 in the valve closing direction opposite to the valve open direction F1 as shown in FIGS. 3 to 6. The valve closing stopper 65 is placed adjacent to an outer periphery of the first side part 39AA of the valve element 39 in planar view of the valve element 39 so that the valve closing stopper 65 is engageable with an upper surface of the first side part 39AA. The valve closing stopper 65 of an L-shape has a short side portion 65a fixed to an upper surface of the valve seat 38 and a long side portion 65b placed above the upper surface of the first side part 39AA to be contacted with the upper surface of the first side part 39AA. The valve closing stopper 65 may be fixed to the valve seat 38 by welding, for example. Under the fully-closed state of the valve element 39, a slight clearance G2 is created between the upper surface of the first side part 39AA and the long side portion 65b of the valve closing stopper 65. The clearance G2 in FIG. 6 is illustrated larger than its actual dimension for better understanding. As shown in FIG. 5, the valve closing stopper 65 of the present embodiment is placed on a first virtual line L10 extending orthogonal to the main axis L1 of the rotary shaft 40 centering about the axis L2 of the valve element 39, extending from the axis L2 of the valve element 39 to the first side part 39AA in planar view of the valve element 39. Namely, in the present embodiment, the valve closing stopper 65 is located closer to the first virtual line L10 (on a position close to the first virtual line L10) than a middle point of an angular range θ1 (see FIG. 13) which will be explained below.

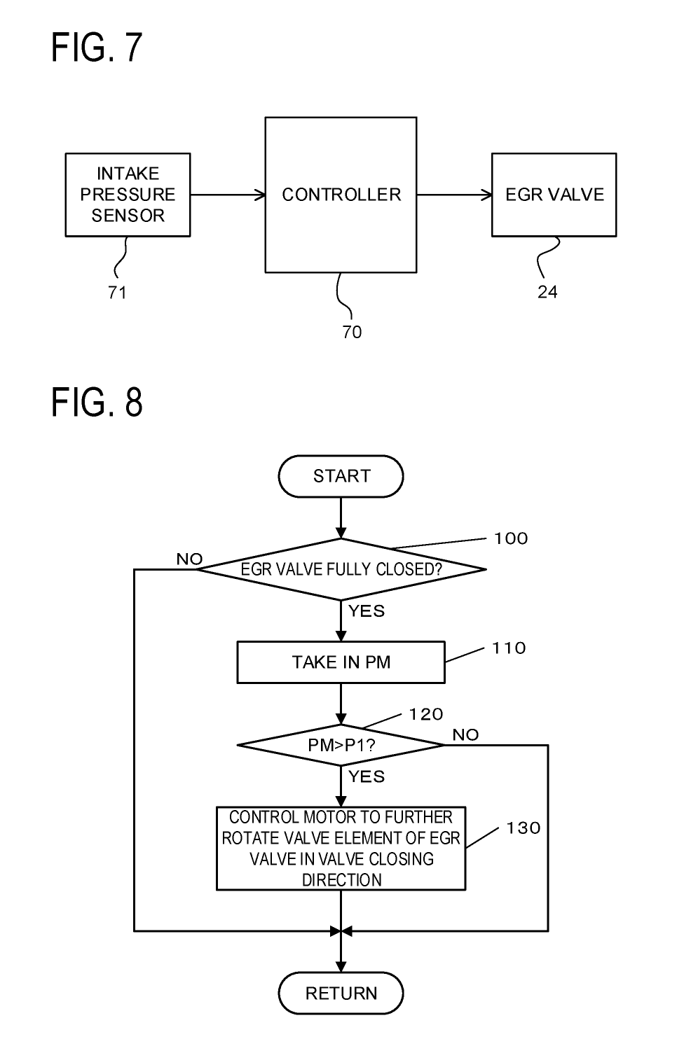

Further, second rotation urging members are provided in the present embodiment to urge and further rotate the fully-closed valve element 39 in the valve closing direction. FIG. 7 is a block diagram showing an electrical configuration of the second rotation urging member. As shown in FIG. 7, the configuration of the present embodiment includes a controller 70 to control open and close of the EGR valve 24 and an intake pressure sensor 71 (see FIG. 1) to detect an intake pressure PM in the surge tank 8a of the intake manifold 8. To the controller 70, the intake pressure sensor 71 and the EGR valve 24 are connected. The controller 70 is configured to carry out the following rotation urging control for the EGR valve 24. In the present embodiment, one example of the second rotation urging member of the present invention is configured with the motor 42 of the EGR valve 24, the speed reducing mechanism 43, and the controller 70.

FIG. 8 is a flow chart indicating a process of the rotation urging control. When the process proceeds to this routine, the controller 70 determines whether the EGR valve 24 is fully closed in a step 100. The controller 70 makes this determination by determining whether the EGR valve 24 is under fully-closing control. When the determination result is affirmative, the controller 70 proceeds the process to a step 110. When the determination result is negative, the process returns to the step 100.

In the step 110, the controller 70 takes in an intake pressure PM which is detected by the intake pressure sensor 71.

In the step 120, subsequently, the controller 70 determines whether the intake pressure PM is higher than a predetermined value P1. The predetermined value P1 is a set value set on an assumption that the high-pressure supercharging pressure acts on the intake manifold 8 by operation of the supercharger 5. The controller 70 proceeds the process to a step 130 when the determination result is affirmative and returns the process to the step 100 when the determination result is negative.

In the step 130, the controller 70 performs the control of the motor 42 to further rotate the valve element 39 of the EGR valve 24 in the valve closing direction from the fully-closed state. In the present embodiment, the controller 70 may perform PWM (Pulse Width Modulation) control for the motor 42, for example. Namely, output of the motor 42 is regulated by changing duty ratio (DUTY) of current flow to the motor 42. Subsequently, the controller 70 returns the process to the step 100.

According to the above control, the controller 70 is made to perform the control of the motor 42 to urge and further rotate the valve element 39 in the valve closing direction from the fully-closed state when the valve element 39 is under the fully-closed state and the high-pressure intake air, i.e., the supercharging pressure acts on the downstream passage 36BB.

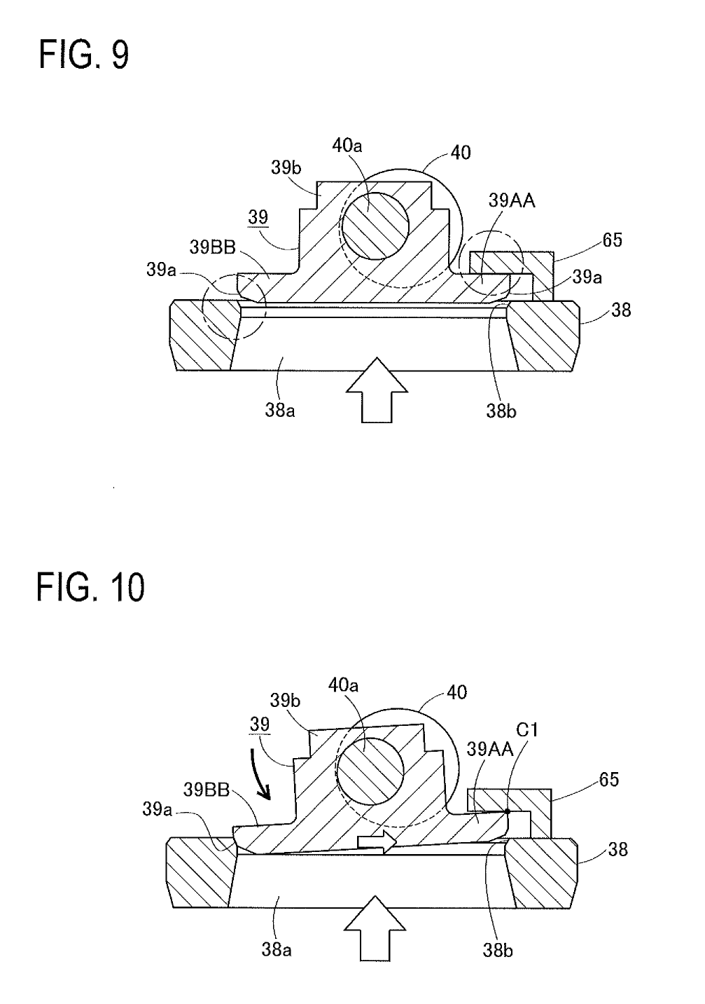

According to the above-mentioned EGR valve 24 including the double eccentric valve of the present embodiment, the valve closing stopper 65 is provided engageable with the first side part 39AA of the valve element 39 so that the fully-closed valve element 39 is restricted its rotation in the valve closing direction opposite to the valve open direction F1. Accordingly, when the supercharging pressure acts on the downstream passage 36BB to lift the fully-closed valve element 39 from the valve seat 38, for example, the first side part 39AA of the valve element 39 contacts the valve closing stopper 65 as shown in FIG. 9, so that the valve element 39 is restrained from rising. In other words, contact of the valve element 39 with the valve closing stopper 65 mainly restricts tremor of the valve element 39 in a rotation direction about the rotary shaft 40. At this time, while the first side part 39AA contacts the valve closing stopper 65 as shown in FIG. 9, the sealing surface 39a on both the first side part 39AA and the second side part 39BB is separated from the seat surface 38b of the valve seat 38. In FIG. 9, a distance between the valve seat 38 and the valve element 39 is exaggerated for better understanding. The return spring 50 urges the fully-closed valve element 39 to rotate in the valve closing direction. FIG. 9 is a sectional view of the valve seat 38, the valve element 39, and others.

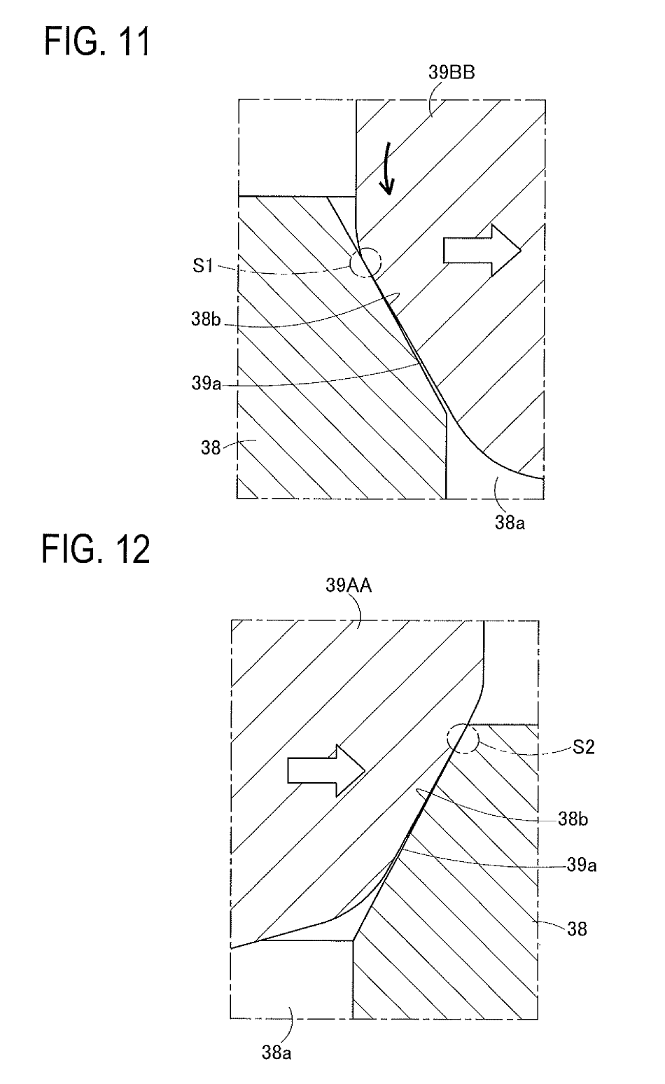

Accordingly, the valve element 39 is urged and rotated in the valve closing direction about a contact point C1 of the first side part 39AA and the valve closing stopper 65 as a fulcrum as shown in FIG. 10, and the valve element 39 laterally tremors to bring the sealing surface 39a into contact with the seat surface 38b of the valve seat 38. Namely, when the sealing surface 39a of the second side part 39BB contacts the seat surface 38b of the valve seat 38 as shown in FIG. 11, the valve element 39 is made to laterally move along a taper of the seat surface 38b. Accordingly, also in the first side part 39AA, the sealing surface 39a contacts the seat surface 38b of the valve seat 38 as shown in FIG. 12, so that an entire periphery of the sealing surface 39a is brought in line contact or surface contact with an entire periphery of the seat surface 38b between the valve element 39 and the valve seat 38. This configuration achieves prevention of rise of the valve element 39 when the valve element 39 is subjected to the force of lifting the valve element 39 from the valve seat 38 in the rotation direction about the rotary shaft 40, and thus the valve element 39 can be sealed with the valve seat 38. This can prevent leakage of the intake air between the valve element 39 and the valve seat 38. As a result, no intake air flows in the exhaust passage 3, and thus occurrence of backfire or the like can be prevented. FIG. 10 is a sectional view of the valve seat 38, the valve element 39, and others. FIG. 11 is a partial enlarged sectional view of the valve seat 38 and the second side part 39BB. FIG. 12 is a partial enlarged sectional view of the valve seat 38 and the first side part 39AA.

According to the configuration of the present embodiment, when the valve element 39 is under the fully-closed state and the high-pressure supercharging pressure acts on the downstream passage 36BB, the valve element 39 is further urged and rotated in the valve closing direction by the controller 70, the motor 42, and others. Accordingly, to prevent rise of the valve element 39 from the valve seat 38 caused by the action of the high-pressure supercharging pressure, the valve element 39 laterally tremors as similar to the above to bring the sealing surface 39a into contact with the seat surface 38b of the valve seat 38. Therefore, even if the high-pressure supercharging pressure to lift the fully-closed valve element 39 from the valve seat 38 acts on the valve element 39, the valve element 39 and the valve seat 38 can be sealed, preventing leakage of the intake air between the valve element 39 and the valve seat 38.

Further, according to the configuration of the present embodiment, the valve element 39 and the leading end portion 40c of the rotary shaft 40 are placed in the upstream passage 36AA, and the valve element 39 is provided to seat in the valve seat 38. Accordingly, an exhaust pressure acting on the upstream passage 36AA acts in a direction where the valve element 39 seats in the valve seat 38 during valve full-closing. This can therefore effectively achieve prevention of EGR gas leakage from the EGR valve 24 to the intake passage 2 by use of the exhaust pressure acting on the upstream passage 36AA during the valve fully-closing.

### Second Embodiment

A second embodiment embodying an EGR valve including a double eccentric valve of the present invention is explained in detail with reference to the accompanying drawings.

In the following explanation, similar or identical parts and components to those of the first embodiment are assigned with the same reference signs as those in the first embodiment and their explanations are omitted, and therefore, the following explanation is made with a focus on the differences from the first embodiment.

The present embodiment is different from the first embodiment in its arrangement of the valve closing stopper 65. FIG. 13 is a plane sectional view of a part of the EGR valve 24 in the fully-closed state. In the present embodiment, the valve closing stopper 65 is placed adjacent to the outer periphery of the valve element 39 within the angular range θ1 defined by the first virtual line L10 extending orthogonal to the main axis L1 of the rotary shaft 40 centering about the axis L2 of the valve element 39, extending from the axis L2 of the valve element 39 to the first side part 39AA, and the second virtual line L20 extending in parallel with the main axis L1 of the rotary shaft 40 from the axis L2 of the valve element 39 to the leading end portion 40c of the rotary shaft 40 in planar view of the valve element 39 as shown in FIG. 13. Especially in the present embodiment, the valve closing stopper 65 is placed in a middle point of the angular range θ1. This middle point of the angular range θ1 may be, for example, a position of “45°” in a clockwise direction with respect to the first virtual line L10 as a reference position (0°) and a position in a range of “40° to 50°” in the clockwise direction from the reference position (0°) in FIG. 13.

This configuration of the present embodiment can achieve the similar operations and effects to the first embodiment. Further, the valve closing stopper 65 of the present embodiment is placed adjacent to the outer periphery of the valve element 39 within the angular range θ1 defined by the first virtual line L10 and the second virtual line L20. Therefore, contact of the valve element 39 with the valve closing stopper 65 restricts at least any one of the tremor of the valve element 39 in the rotation direction about the rotary shaft 40 and the tremor of the valve element 39 in the axis L2 direction of the valve element 39. The fully-closed valve element 39 can be thus effectively prevented from rising from the valve seat 38. Especially in the present embodiment, the valve closing stopper 65 is placed in the middle of the angular range θ1 to allow the valve element 39 to contact the valve closing stopper 65, so that the tremor of the valve element 39 in the rotation direction about the rotary shaft 40 and the tremor of the valve element in the direction along the axis L2 of the valve element 39 are both restricted to the maximum. Therefore, even if the high-pressure supercharging pressure to lift the valve element 39 from the valve seat 38 is subjected to the valve element 39 during the valve fully-closing, the valve element 39 and the valve seat 38 can be effectively sealed, thus effectively preventing leakage of the high-pressure intake air between the valve element 39 and the valve seat 38.

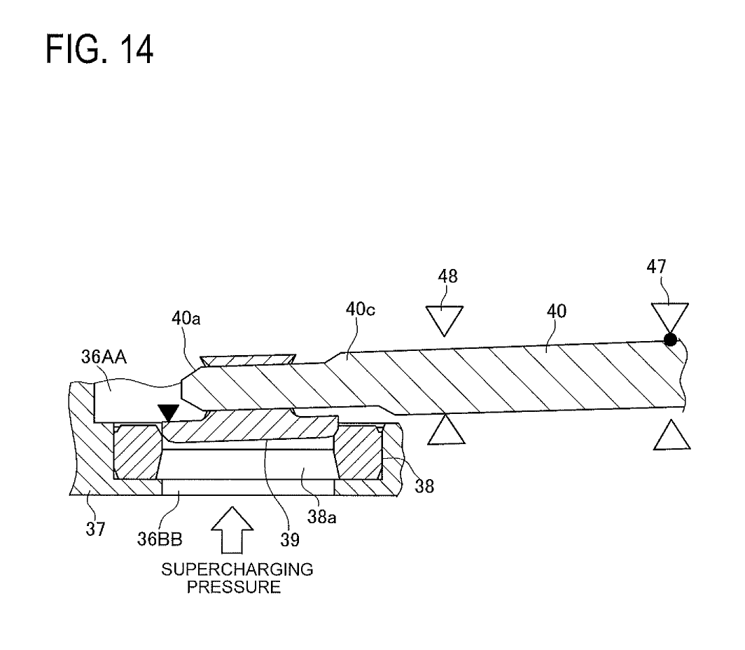

FIG. 14 is a sectional side view of a part of the EGR valve 24 in the fully-closed state. As shown in FIG. 14, the rotary shaft 40 having the leading end portion 40c fixed with the valve element 39 is supported in cantilever configuration by the two bearings 47 and 48 in the valve housing 45 in the present embodiment. There is accordingly some unavoidable bearing backlash among the rotary shaft 40 and the two bearings 47 and 48. This leads to some backlash between the valve element 39 and the valve seat 38 in an upper and lower direction (an upper and lower direction in FIG. 14) of the valve element 39. Prevention of rise of the valve element 39 in the upper and lower direction can be achieved by pressing the valve element 39 with the minimum force (torque) at a point indicated with a black triangle in FIG. 14 (a point on an extended line of the main axis L1 of the rotary shaft 40). However, this position is the most inferior point for preventing rise of the valve element 39 in the rotation direction (in an open and close direction). On the other hand, for preventing rise of the valve element 39 in this rotation direction, the valve element 39 can be pressed with the minimum force (torque) at a point indicated with a black triangle in FIG. 13 (the furthest position from the axis L2 of the valve element 39 on the first virtual line L10). Thus, in the present embodiment, the valve closing stopper 65 is placed in the middle of the angular range θ1 so that the valve element 39 is prevented from both rising in the upper and lower direction and rising in the rotational direction of the valve element 39 by the smaller complex force (torque).

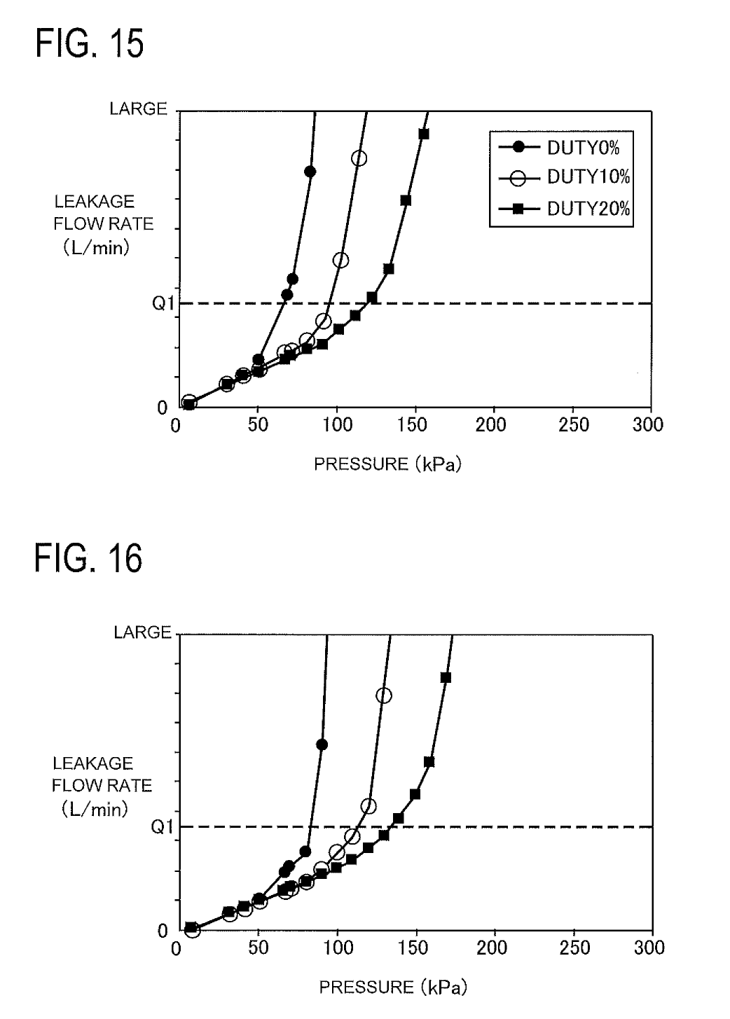

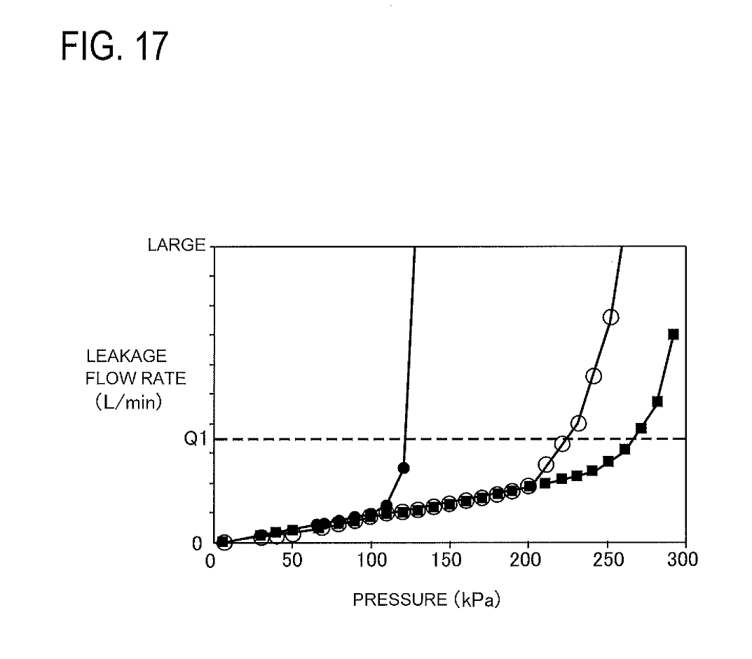

FIGS. 15 to 17 are graphs each showing a relationship of a pressure (supercharging pressure) applied to the valve element 39 and a leakage flow rate of the intake air leaking out from a space between the valve seat 38 and the valve element 39. In FIGS. 15 to 17, marks of “a black circle”, “a white circle”, and “a black rectangle” indicate differences in the duty ratio (DUTY) of the current flow (the black circle: 0%, the white circle: 10%, the black rectangle: 20%) that is supplied to the motor 42. FIG. 15 shows an example where the valve closing stopper is in a position of “−45°” in the counterclockwise direction with reference to the first virtual line L10 in FIG. 14. FIG. 16 shows an example in a position of “0°” (the first embodiment), and FIG. 17 shows an example in a position of “45°” in the clockwise direction (the middle point in the angular range θ1). In the example of “−45°” in FIG. 15, the valve closing stopper 65 can only oppose the pressure of “110 kPa” to the maximum for restraining the leakage flow rate to a predetermined reference value Q1 or less. In the example of “0°” in FIG. 16, similarly, the valve closing stopper 65 can only oppose to the pressure of “140 kPa” to the maximum. On the other hand, in the example of “45°” in FIG. 17 as the example of the present embodiment, the valve closing stopper 65 can oppose to the pressure of “260 kPa” to the maximum for suppressing the leakage flow rate to the reference value Q1 or less. According to the configuration of the present embodiment, the valve closing stopper 65 is placed in the middle point of the angular range θ1, and thus the valve element 39 can be effectively prevented from rising against the twice the supercharging pressure compared with the configuration of the first embodiment.

### Third Embodiment

A third embodiment embodying an EGR valve including a double eccentric valve of the present invention is explained in detail with reference to the accompanying drawings.

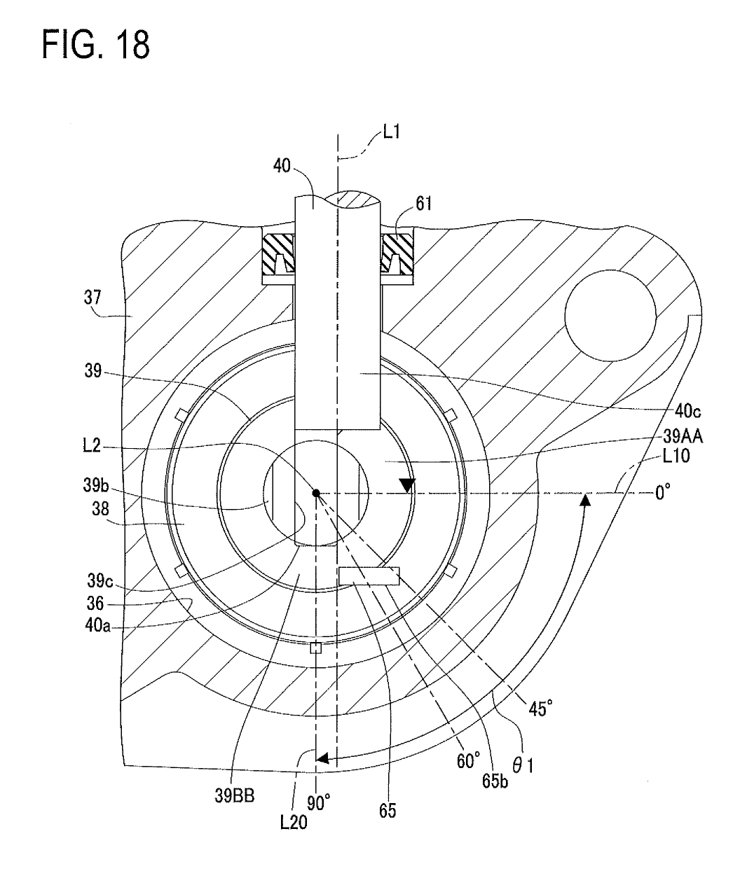

The present embodiment is different in its arrangement of the valve closing stopper 65 from the configuration of the above embodiments. FIG. 18 is a plane sectional view of a part of the EGR valve 24 in the fully-closed state. In the present embodiment, the valve closing stopper 65 is placed adjacent to the outer periphery of the valve element 39 within the angular range θ1 defined by the first virtual line L10 and the second virtual line L20 centering about the axis L2 of the valve element 39 in planar view of the valve element 39 as shown in FIG. 18. Especially in the present embodiment, the valve closing stopper 65 is placed closer to the second virtual line L20 than the middle point in the angular range θ1, specifically in a position of “60°” in the clockwise direction from the reference position (0°) as one example. In the present embodiment, the valve closing stopper 65 is arranged such that the long side portion 65b is located orthogonal to the main axis L1 on a side closer to the first side part 39AA than the main axis L1 in planar view of the valve element 39.

The configuration of the present embodiment can achieve the operations and effects similar to the second embodiment. Additionally, in the present embodiment, the valve closing stopper 65 is located in the position of “60°” in the clockwise direction from the reference position (0°) as one example on the side closer to the second virtual line L20 than the middle point of the angular range θ1. Accordingly, contact of the valve element 39 with the valve closing stopper 65 in this configuration mainly restricts the tremor of the valve element 39 in the direction of the axis L2 of the valve element 39. Therefore, the valve element 39 can be prevented from rising from the valve seat 38 in the direction of the axis L2 of the valve element 39. Therefore, the flow rate characteristics (flow rate resolution) of the EGR gas in a small open range of the EGR valve 24 is especially improved.

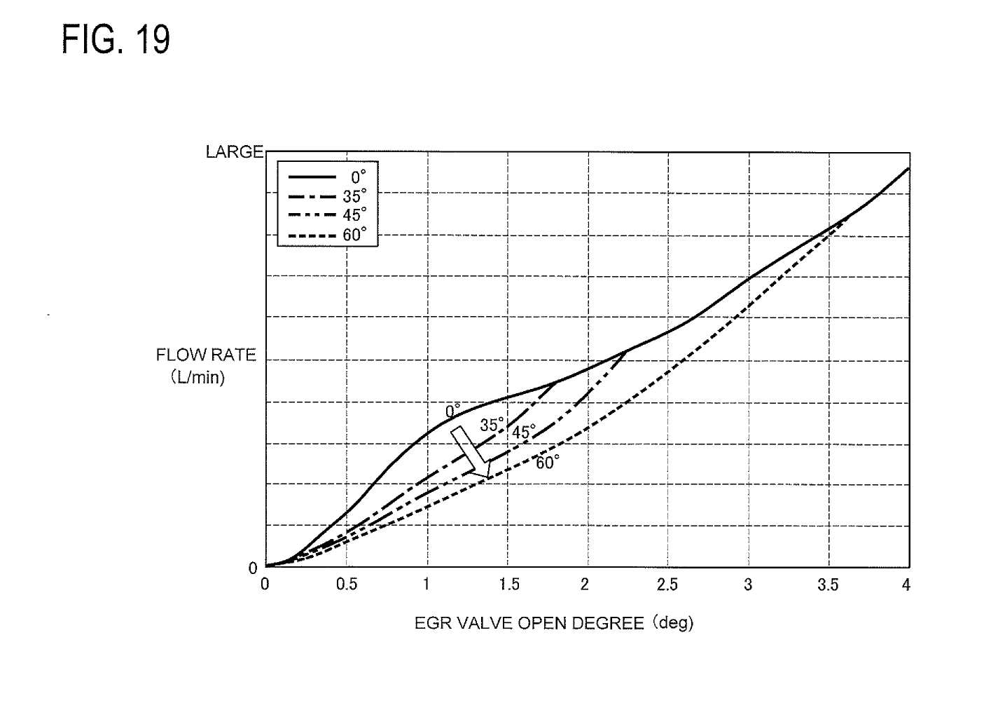

FIG. 19 is a graph showing one example of the flow rate characteristics of the EGR gas with respect to an open degree of the EGR valve 24. In the graph, different curved lines indicate differences in arrangement (an angle from the reference position (0°)) of the valve closing stopper 65. Namely, a thick bold line indicates the example of the reference position “0°” (the first embodiment), a thick dashed line indicates an example of “35°”, a thick double-dashed line indicates the example of “45°” (the second embodiment), and a thick broken line indicates the example of “60°” (the third embodiment). As shown in this graph, the more the angle from the reference position (0°) increases, the higher the flow rate resolution of the EGR gas becomes in the small open range (“0.5° to 1.5°”, for example). Further, the flow rate resolution becomes the highest in the example of “60°” as similar to the present embodiment.

### Fourth Embodiment

A fourth embodiment embodying an EGR valve including a poppet valve is explained in detail with reference to the accompanying drawings.

When a poppet valve is adopted instead of the double eccentric valve for the EGR valve, a similar problem to the examples of the double eccentric valve may occur depending on a positional relationship of a valve element and a valve seat. To address this problem, the present embodiment is exemplified with a case of adopting the poppet valve for the EGR valve.

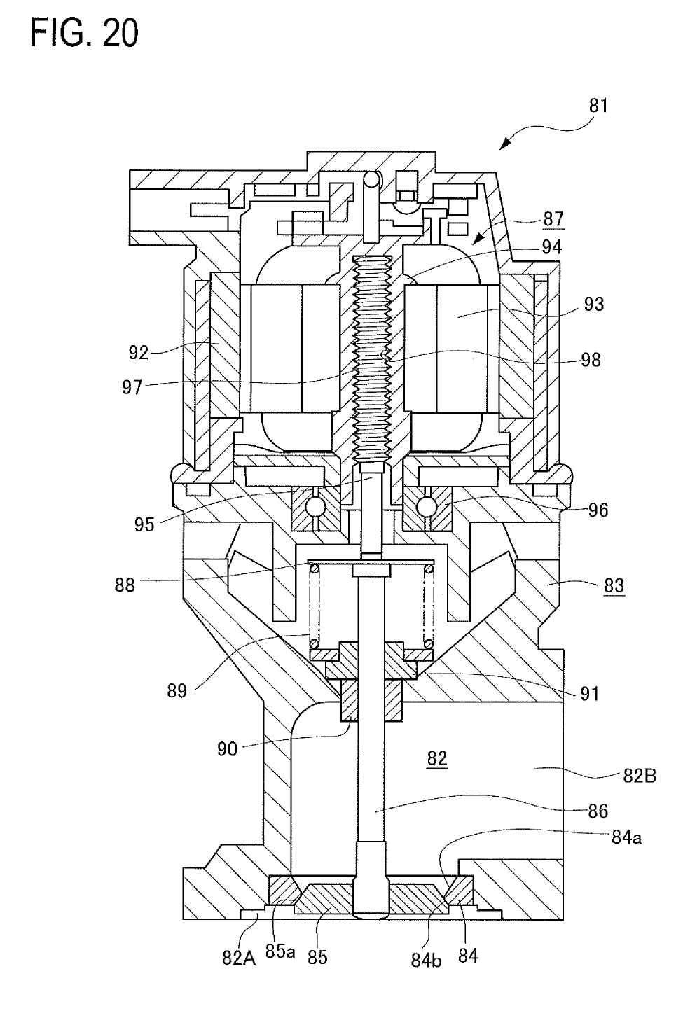

The present embodiment is different from each of the above embodiments in its configuration of the EGR valve. FIG. 20 is a sectional view of an EGR valve 81 including a DC-motor-operated poppet valve. The EGR valve 81 of the present embodiment consists of the poppet valve. Namely, as shown in FIG. 20, the EGR valve 81 is provided with a housing 83 having a passage 82, a valve seat 84 provided in the passage 82, a valve element 85 allowed to seat in the valve seat 84, a valve shaft 86 to cause straightforward reciprocal movement (stroke movement) of the valve element 85, and a DC motor 87 to cause the stroke movement of the valve shaft 86 with the valve element 85 in its axial direction.

The valve element 85 is fixed to a lower end portion of the valve shaft 86, and a spring receiver 88 is provided on an upper end portion of the valve shaft 86. Between the spring receiver 88 and the housing 83, a valve closing spring 89 (a first valve-closing urging member) to urge the valve element 85 and the valve shaft 86 in a direction where the valve element 85 is seated in the valve seat 84, namely in the valve closing direction, is provided. The housing 83 is provided with a thrust bearing 90 to support the valve shaft 86 in a movable manner in an axial direction. The housing 83 is further provided with a sealing member 91 adjacent to the thrust bearing 90.

The DC motor 87 is mainly provided with an electromagnetic coil 92, a rotor 94 including a magnet 93, and a rotary shaft 95. The rotor 94 is rotatably supported in the housing 83 via a radial bearing 96. The electromagnetic coil 92 is fixed to the housing 83 around the rotor 94. The rotary shaft 95 placed coaxially with the valve shaft 86 has a lower end portion for pressing the valve shaft 86. A male thread 97 is provided in an upper part of the rotary shaft 95. In a center of the rotor 94, a female thread 98 to be engaged with the male thread 97 is provided. The EGR valve 81 is configured such that the DC motor 87 is driven to excite the electromagnetic coil 92 and rotate the rotor 94, and this rotation movement of the rotor 94 is transformed to a stroke movement of the rotary shaft 95 through the female thread 98 and the male thread 97, thus pressing the valve shaft 86 at the lower end portion of the rotary shaft 95. An open degree of the valve element 85 with respect to the valve seat 84 is thereby adjusted. During fully closing of the EGR valve 81, the valve element 85 is seated in the valve seat 84 to close the valve.

The valve seat 84 of an annular shape includes a valve hole 84a and an annular seat surface 84b formed in the valve hole 84a. The valve element 85 of an almost conical shape has an annular sealing surface 85a on its outer periphery in correspondence with the seat surface 84b. The passage 82 is partitioned into an upstream passage 82A (on a lower side) and a downstream passage 82B (on an upper side) with respect to the valve seat 84b as a boundary, and the valve element 85 is placed in the upstream passage 82A. The upstream passage 82A is connected to an exhaust passage via an EGR passage. The downstream passage 82B is connected to an intake passage via the EGR passage. In the present embodiment, the valve seat 84 is provided to be engaged with the valve element 85 (a valve closing restriction member) to restrict movement of the fully-closed valve element 85 in the valve closing direction.

In the present embodiment, the EGR valve 81 is used instead of the EGR valve 24 for the gasoline engine system shown in FIG. 1. Further, in the present embodiment, this EGR valve 81 is used instead of the EGR valve 24 in the block diagram shown in FIG. 7. Namely, the controller 70 is configured to perform control of the DC motor 87 to further urge the valve element 85 in the valve closing direction from the fully-closed state when the valve element 85 is in the fully-closed state and the high-pressure supercharging pressure acts on the downstream passage 82B (a second valve-closing urging member).

As explained above, according to the configuration of the poppet-type EGR valve 81 of the present embodiment, the valve element 85 in the fully-closed state is engaged with the valve seat 84, and thus the valve element 85 is restricted its movement in the valve closing direction (in an upward direction). Further, in the fully-closed state, the valve element 85 is urged in the valve closing direction by the valve closing spring 89. Accordingly, the valve element 85 remains in the fully-closed state even when the downstream passage 82B is subjected to some intake pressure (positive pressure), so that rise of the valve element 85 from the valve seat 84 is restrained. When the valve element 85 is in the fully-closed state and the high-pressure supercharging pressure acts on the downstream passage 82B, the controller 70 controls the DC motor 87 to further urge the valve element 85 in the valve closing direction. Accordingly, even when the high-pressure supercharging pressure acts on the fully-closed valve element 85, the valve element 85 is prevented from rising from the valve seat 84, thus maintaining the contact state of the sealing surface 85a of the valve element 85 with the seat surface 84b of the valve seat 84. Therefore, the valve element 85 and the valve seat 84 can be sealed irrespective of high supercharging pressure acting on the fully-closed valve element 85, preventing intake leakage between the valve element 85 and the valve seat 84. Prevention of rise of the valve element 85 due to the supercharging pressure achieves cooperation of the valve closing spring 89 and the DC motor 87, so that the valve closing spring 89 and the DC motor 87 can achieve their downsizing and cost reduction with no need of increase in size and high-resolution.

The present invention is not limited to the above embodiments and may be partly modified in its configuration without departing from the scope of the invention.

(1) In the above-mentioned first embodiment, the controller 70, the motor 42, and others (the second rotation urging member) perform control of the EGR valve 24 to further urge and rotate the valve element 39 in the valve closing direction only when the valve element 39 is in the fully-closed state and the high intake pressure PM (supercharging pressure) higher than the predetermined value P1 acts on the downstream passage 36BB. Alternatively, a controller, a motor, and others (a first rotation urging member) may be configured to further urge and rotate a valve element in a valve closing direction anytime when the valve element is in the fully-closed state.

(2) In the above-mentioned first embodiment, a double eccentric valve of the present invention is embodied in the EGR valve 24. Alternatively, other than the EGR valve, the double eccentric valve of the present invention may be embodied in any flow rate regulation valves which regulate a flow rate of fluid.

### INDUSTRIAL APPLICABILITY

The present invention may be, for example, utilized for an EGR valve of an EGR device mounted in an engine.

### REFERENCE SIGNS LIST

24 EGR valve

36 Passage

36AA Upstream passage

36BB Downstream passage

38 Valve seat

38a Valve hole

38b Seat surface

39 Valve element

39a Sealing surface

39AA First side part

39BB Second side part

40 Rotary shaft

40a Pin

40c Leading end portion

42 Motor (Second rotation urging member)

43 Speed reducing mechanism

45 Valve housing

47 First bearing

48 Second bearing

50 Return spring (First rotation urging member)

65 Valve closing stopper

70 Controller (Second rotation urging member)

L1 Main axis (Axis of rotary shaft)

L2 Axis (Axis of valve element)

L3 Sub-axis (Axis of pin)

L10 First virtual line

L20 Second virtual line

θ1 Angular range

V1 Virtual surface

1. A double eccentric valve comprising:
a valve seat of an annular shape including a valve hole and an annular seat surface formed in the valve hole;
a valve element of a disc like shape including an annular sealing surface formed on an outer periphery in correspondence with the seat surface;
a housing including a passage in which fluid flows;
the valve seat and the valve element being placed in the passage,
the passage being partitioned into an upstream passage and a downstream passage with respect to the valve seat as a boundary and the valve element being placed in the upstream passage,
a rotary shaft configured to rotate the valve element; and
a bearing rotatably supporting the rotary shaft in the housing,
an axis of the rotary shaft being placed away from the sealing surface of the valve element and placed away from an axis of the valve element,
the valve element including a first side part and a second side part partitioned with respect to a boundary defined by a virtual surface extending in parallel with a direction extending from the axis of the rotary shaft to the axis of the valve element, and
the first side part configured to rotate toward the downstream passage and the second side part configured to rotate toward the upstream passage when the valve element rotates in a valve open direction from a fully-closed state in which the valve element is seated in the valve seat,
wherein the double eccentric valve comprises:
a valve closing stopper engageably provided in the first side part to restrict rotation of the valve element in the fully-closed state toward a valve closing direction which is opposite to the valve open direction; and
a first rotation urging member to urge and rotate the valve element in the fully-closed state toward the valve closing direction.

2. The double eccentric valve according to claim 1 comprises a second rotation urging member to urge and further rotate the valve element in the valve closing direction when the valve element is in the fully-closed state and high-pressure fluid acts on the downstream passage.

3. The double eccentric valve according to claim 1, wherein
the valve closing stopper is placed adjacent to an outer periphery of the first side part of the valve element within an angular range defined by a first virtual line extending orthogonal to the axis of the rotary shaft centering about the axis of the valve element, extending from the axis of the valve element to the first side part, and a second virtual line extending in parallel with the axis of the rotary shaft from the axis of the valve element to a leading end portion of the rotary shaft in planar view of the valve element.

4. The double eccentric valve according to claim 3, wherein the valve closing stopper is placed in a middle point of the angular range.

5. The double eccentric valve according to claim 3, wherein the valve closing stopper is placed on a side closer to the first virtual line than the middle point of the angular range.

6. The double eccentric valve according to claim 3, wherein the valve closing stopper is placed on a side closer to the second virtual line than the middle point of the angular range.

7. A poppet valve comprising:
a valve seat of an annular shape including a valve hole and an annular seat surface formed in the valve hole;
a valve element of an almost conical shape including an annular sealing surface formed on an outer periphery in correspondence with the seat surface;
a housing including a passage in which fluid flows;
the valve seat and the valve element being placed in the passage,
the passage being partitioned into an upstream passage and a downstream passage with respect to the valve seat as a boundary and the valve seat being placed in the upstream passage,
a valve shaft configured to move the valve element reciprocally and straightforward; and
a bearing for movably supporting the valve shaft in an axial direction,
the valve element being configured to move toward the upstream passage when the valve element moves in a valve open direction from a fully-closed state in which the valve element is seated in the valve seat,
wherein the valve seat is provided to be engageable with the valve element to restrict movement of the valve element in the fully-closed state toward a valve closing direction, and
the poppet valve includes:
a first valve-closing urging member to urge the valve element in the fully-closed state in the valve closing direction; and
a second valve-closing urging member to further urge the valve element in the valve closing direction when the valve element is in the fully-closed state and high-pressure fluid acts on the downstream passage.

8. The double eccentric valve according to claim 2, wherein
the valve closing stopper is placed adjacent to an outer periphery of the first side part of the valve element within an angular range defined by a first virtual line extending orthogonal to the axis of the rotary shaft centering about the axis of the valve element, extending from the axis of the valve element to the first side part, and a second virtual line extending in parallel with the axis of the rotary shaft from the axis of the valve element to a leading end portion of the rotary shaft in planar view of the valve element.
